(19) United States
(12) Patent Application Publication
(10) Pub. No.: US 2022/0267108 A1
(43) Pub. Date: Aug. 25, 2022

(54) A CONTACTLESS LIQUID APPLICATION APPARATUS AND METHOD

(71) Applicant: XEIKON MANUFACTURING N.V., LIER (BE)

(72) Inventors: Kim Louis Josephus HOEFNAGELS, SCHOTEN (BE); Thomas PRAET, WESPELAAR (BE); Kurt Gustaaf Maria MAMPAEY, RUMST (BE); Bjorn LEYNEN, PELT (BE); Tom RAMAEKERS, MORTSEL (BE); Jürgen Norbert Bart DEVLIEGHERE, BORGERHOUT (BE); Tom Rik May BROECKX, RAMSEL (BE)

(21) Appl. No.: 17/625,492

(22) PCT Filed: Jul. 2, 2020
(86) PCT No.: PCT/EP2020/068635

§ 371 Date: Jan. 7, 2022

(30) Foreign Application Priority Data
Jul. 11, 2019 (NL) 2023478
Jul. 11, 2019 (NL) 2023480

(51) Int. Cl. B65H 5/22; B41J 11/00

(52) U.S. Cl. CPC B65H 5/224; B41J 11/007; B41J 11/0085; B41J 11/0095; B65H 2406/3221; B65H 2406/3222; B65H 2406/3622; B65H 2406/41; B65H 2801/03

(57) ABSTRACT

A contact-less liquid application apparatus, and in particular a printing apparatus, for applying a liquid in a contact-less manner on a moving medium. The liquid application apparatus includes a liquid application means configured for applying a liquid on a moving medium, a media transport system configured for moving the medium in a movement direction at a distance of the liquid application means, and a flow control means configured to evacuate at least a portion of the air displaced by the moving of the medium, at least before the medium is in a liquid application position, where the liquid application position is a position in which the liquid application means is applying liquid on the medium.

### FIELD OF INVENTION

The field of the invention relates to a media transport system, in particular for use in a printing apparatus. The invention further relates to a printing apparatus comprising a media transport system, and to a printing method.

### BACKGROUND

Printing may be performed by means of several alternative printing methods. Contact printing methods, such as relief or intaglio printing methods, typically bring the print medium in contact with a print block or plate or matrix by means of printing rollers. Contactless printing methods, such as inkjet printing methods, use printheads which propel droplets of ink onto the print medium from a distance.

When using a contactless printing method, typically the print media are arranged on the surface of a print table by means of applying a vacuum through the surface itself. The surface of the print table may be fixed or may be a conveyor belt. In such media transport systems, the print media can have a smaller width than the surface of the print table, thereby not covering the entire width of the print table. In such a situation, the print table will apply a vacuum over the entire width, i.e. also there where no print medium is present. This may cause ink which is jetted by the printheads onto the print medium to be diverted, leading to printing imperfections on the print medium. To avoid such disturbing suction flows adjacent the print media, existing methods consist in arranging a cover over the holes which are not covered by the print media. However, such techniques are usually slow and cumbersome for an operator of the printing apparatus.

### SUMMARY

The object of embodiments of the invention is to provide a media transport system allowing for an improved transport of media, and in particular print media, wherein the environment of the media transport system is not significantly influenced by suction flows used for fixing the media on a carrier.

According to a first aspect of the invention, the media transport system comprises a carrier, a drive means, and a plurality of suction groups. The carrier has a support surface with a plurality of holes and is configured for supporting a medium, typically a print medium, on the upper surface thereof. The drive means is configured for moving at least a portion of the carrier with the medium or for moving the medium relative to the carrier, in a movement direction with a moving speed. The plurality of suction groups is arranged between the plurality of holes and at least one suction means. For each suction group, at least one valve means is operable to allow or interrupt a suction flow through one or more holes of the plurality of holes. Each at least one valve means is configured or controlled to automatically control a suction force through said at least one hole taking into account the coverage area of the medium on the upper surface of the carrier.

Preferably, each at least one valve means is configured or controlled such that automatically a suction force is exerted when a medium is present above the at least one hole associated with the corresponding suction group, and such that no suction force is exerted through said at least one hole when no medium is present above said at least one hole. However, further developed embodiments may further adjust the suction flows caused by the valve means based also on other parameters than the area covered by the medium.

It is noted that the medium may be fixed on the carrier, and at least a portion of the carrier with the plurality of holes may be moved, in which case there may be no suction force through the non-covered holes where no medium is present, wherein the non-covered holes do no change during the transport. However, in further developed embodiments, a suction flow through some of the non-covered holes may be generated for other purposes, see the fourth aspect described below. In other embodiments, the medium may be moved relative to the carrier, and in this case the plurality of holes is static and the non-covered holes change during the transport operation. According to exemplary embodiments of the invention, at least during a portion of the transport operation, those holes which are covered by a printing medium may be in fluid communication with a suction means, typically a vacuum source, and the holes which are not covered by the printing medium are not in fluid communication with the suction means, or allow only a limited or diminished flow through the holes. It is noted that not all holes covered by a printing medium have to be in fluid communication with a suction means, and that in certain cases it may be sufficient to cause a suction flow through only a subset of the covered holes, e.g. the holes near the edges of the medium and some holes in a centre of the medium. This is achieved by having a plurality of suction groups with valve means which are operated automatically. In that manner, any disturbing suction flows are avoided or limited, the energy consumption of the suction means can be reduced, and the involvement of an operator in the printing process can be avoided or decreased.

It is further noted that the support surface may be an upper surface of the carrier. This upper surface may be e.g. a horizontal surface or an inclined surface or a curved surface. However, in other embodiments, the support surface may be a lower surface of the carrier. The lower surface may also be a horizontal surface or an inclined surface or a curved surface. Also, the support surface may comprise an upper surface and a lower surface, e.g. the support surface may be a cylindrical surface of a roller. Also, the support surface may comprise a vertical surface.

According to an exemplary embodiment, the drive means is configured for moving at least the upper surface of the carrier with the medium. For example, the carrier may comprise a movable plate with the plurality of holes arranged in a support surface of the plate and a static support structure carrying the plate, wherein the drive means is configured to move the plate. The plate may be rigid or flexible. The plate may be embodied as a movable table or a movable belt.

In a possible embodiment, the plurality of suction groups may extend in the static support structure and the valve means may be arranged in or below the static support structure. In such an embodiment, where the valve means are static, the media transport system may further comprise a controller configured for controlling each valve means in function of the moving speed and in function of a position of the medium on the movable plate.

In another possible embodiment, the valve means may be arranged in the movable plate. The valve means may then be configured for blocking a fluid passage through a hole when no medium is present over said hole and for allowing a fluid passage through said hole when a medium is present over said hole.

According to another exemplary embodiment, the drive means is configured for moving the entire carrier including the valve means.

According to yet another exemplary embodiment, the drive means is configured for moving the medium relative to the carrier.

Each at least one valve means may then comprise one or more closure bodies associated with the one or more holes, each closure body being configured and arranged for blocking a fluid passage through a hole when no medium is present over said hole and for allowing a fluid passage through said hole when a medium is present over said hole. Preferably, the closure body is provided with a portion protruding out of the hole in the closed state of the valve means, wherein said portion can be pressed in the hole when a print medium is arranged over the hole in order to open the valve means. It is noted that the seat for the closure body of the valve means can be formed either in the hole itself or in a passage in the carrier below the hole.

According to an exemplary embodiment, the carrier comprises a plate provided with the plurality of holes and a support structure, and the valve means is arranged either in the plate or in the support structure.

The media transport system may further comprise a controller configured for controlling each valve means in function of the moving speed and in function of a position of the medium on the carrier.

According to an exemplary embodiment, the carrier comprises a belt and/or a table and/or a roller. The surface of the table may be flat or curved, and optionally profiled or segmented. Also, there may be arranged one or more rollers in contact with the medium e.g. to perform an operation on the medium and/or to press the medium against the carrier.

According to an exemplary embodiment, the plurality of holes is such that in operation multiple holes are coupled with a suction group. In that manner the number of valves can be limited.

According to an exemplary embodiment, the shape of a hole of the plurality of holes is any one of the following or a combination thereof: round, rectangular, ring-shaped, oval, polygonal. It is noted that the shape and/or size of the holes can vary across the carrier. Also, it is possible to use a porous material for the upper surface of the carrier such that a large amount of differently shaped holes may be provided.

According to an exemplary embodiment, the media transport system further comprises a measuring device, such as a camera, a scanner such as a line scanner, one or more sensors configured for detecting a position of the medium on the carrier, such as one or more distance sensors and in particular multiple laser distance sensors, wherein the controller is configured to control the valve means in function of the position detected by the measuring device.

Optionally, the measuring device may be configured to measure the warp of the medium. For example, multiple laser distance sensors may be used to detect and measure warp of the medium. Also, a set of simple proximity or optical sensors can be used to estimate the height of the warp, along and/or across the medium. In an exemplary embodiment, the measuring device may be configured to generate a plurality of laser beams at a distance of each other seen in a direction perpendicular to the upper surface of the carrier, e.g. between 0.5 and 50 mm. The laser beams may be directed in a lateral direction perpendicular on the movement direction such that the media are watched sideways and/or in the movement direction such that the media are watched in the movement direction. This allows obtaining a rough estimate of the warp in one or more directions, and in particular in the movement direction and/or in the lateral direction. In addition or alternatively, the measuring device may comprise a camera looking in one or more directions, e.g. in the movement direction (or the opposite direction) and/or in the lateral direction. In addition or alternatively, the measuring device may comprise a scanning system, e.g. comprising lasers. In addition or alternatively, the measuring device may comprise ultrasonic capacitive or inductive distance or proximity sensors.

According to an exemplary embodiment, the media transport system further comprises a mechanical detection system arranged in said carrier for detecting a position of the medium on the carrier, wherein the controller is configured to control the valve means in function of the position detected by the mechanical detection system.

According to an exemplary embodiment, the media transport system further comprises a measuring device configured for detecting warping of the medium, wherein the controller is configured to control the valve means and/or to control the at least one suction means in function of the warp detected by the measuring device. The measuring device may be configured to measure the type of curvature (e.g. edges extending upward or central portion extending upward, i.e. a convex or concave warp) and/or the degree of curvature and/or the warp height, etc. The measuring device may comprise any one or more of the following, as also explained above: a camera, a scanner, one or more sensors. The following considerations may apply when controlling the valve means. The higher the warp height, the more suction force is required to keep such warped medium fixed to the carrier. Thus, the valve means and/or the at least one suction means may be controlled to exert a higher suction force in areas of the medium having a high warp height. Also, the activation timing of the valve means and/or the at least one suction means may be controlled taking into account the warp height. For example, an area with lower warp height may be pulled to the carrier through the activation of the corresponding valve means/suction means before pulling adjacent higher areas to the carrier in order to avoid ripples or creases in the medium. In other words, the valve means and/or suction means may be controlled such that the suction forces exerted on the medium is similar to a force exerted when a roller is rolled from an area with a low warp height to an area with a high warp height.

In a possible embodiment the plurality of suction groups may be associated with a single suction means, e.g. a single vacuum source, and the multiple valve means will control the multiple suction flows. For example, the valve means may be controlled to be more or less open in function of the distance to an edge of the medium, the distance to the printhead, etc. Also, the timing may be controlled, especially when the medium is moving with respect to the carrier. For example, the valve means of a hole may be controlled to open shortly before or shortly after the medium arrives at the hole, and/or may be controlled to close shortly before or shortly after the medium leaves the hole. Indeed, the adjustment of the pressure in the volume between the valve means and the medium may have a regulating effect on airflows around the medium. Also, after a valve means is closed, a lower pressure may remain as long as the volume does not fill up with air, and this may have a further effect on the air flows which can be controlled. Also, the plurality of holes may be arranged in different hole zones with associated holes and/or associated suction groups having a different shape and/or size, in order to obtain hole zones with different suction flows. The size and/or shape of the holes and/or suction groups of one hole zone may be different from the size and/or shape of the holes and/or suction groups of another hole zone. The hole zones may correspond with hole lanes extending parallel to each other in the movement direction, or with lateral hole zones extending in a lateral direction perpendicular on the movement direction, or with a combination of one or more hole lanes and one or more lateral hole zones.

In another possible embodiment multiple suction means are provided in the form of multiple suction sources which may be set or controlled independently of each other. For example, there may be provided multiple suction sources associated with multiple hole zones. The hole zones may correspond with lateral zones extending in a lateral direction perpendicular on the movement direction. In that manner, different suction strengths/pressures may be set in function of the location of the print medium with respect to the support structure. Also, the hole zones may correspond with hole lanes extending in the movement direction and arranged adjacent to each other seen in a lateral direction perpendicular on the movement direction. In that manner, different suction strengths/pressures may be set for different hole lanes. For example, a suction pressure of the suction source for a hole lane covered by a medium where the medium has a high warp height may be higher than a suction pressure of the suction source for another hole lane with a lower warp height. Also, the size and/or shape of the holes of one hole zone may be different from the size and/or shape of the holes of another hole zone. Further, one or more lateral hole zones may be combined with one or more hole lanes.

In exemplary embodiments, when the medium presents warp, the timing of the activation of the suction means and/or of the valve means may be suitable controlled to avoid ripples or creases in the medium. More in particular, the generated suction flows may pull the warped portion gradually onto the carrier in a similar manner as if a roller were to be rolled from the non-warped portion or from a portion with a low warp height towards a portion with a higher warp height.

In exemplary embodiments, the drive means is configured to move the medium at a speed of more than 0.5 m/s, preferably more than 1 m/s. At such speeds, taking into account that after a valve means is closed, a lower pressure may remain as long as the volume does not fill up with air, the open and/or close duration of the valve means can have an effect similar to the effect of a pressure regulator during the short time of the passage of the media.

According to an exemplary embodiment, the carrier is provided with a plurality of passages ending in the plurality of holes in the upper surface, wherein a passage of the plurality of passages has a wall oriented at an angle smaller than 90 degrees with respect to the upper surface. In that manner the suction flow through the passage will not be oriented perpendicular on the surface of the carrier, so that a suction flow flowing out into the environment, is inclined away from the hole.

According to an exemplary embodiment, a hole of the plurality of holes is ring shaped and a corresponding passage of the plurality of passages is conically ring-shaped or prism ring-shaped or a combination thereof, e.g. a passage with a conical outer surface and a prism shaped inner surface or vice versa.

According to an exemplary embodiment, the plurality of holes comprises more than 100 holes. Preferably, the distance between adjacent holes is between 1 mm and 400 mm, preferably between 4 mm and 400 mm. The distance may vary from one location to the next. Also, when the holes are arranged according to a pattern, the distance between adjacent holes in a first direction may be different from the distance between adjacent holes in a different second direction. For example, the pattern may be such that there are less or no holes underneath or in the vicinity of printheads, and/or such that the pattern is different at a medium infeed location and/or at a medium outfeed location. Also, the plurality of holes may be arranged in different hole zones, wherein a first hole zone has a first pattern of holes having a first shape and/or size, and wherein a second hole zone has a second pattern of holes having a second shape and/or size, wherein the second pattern is different from the first pattern and/or the second shape and/or size is different from the first shape and/or size, in order to obtain hole zones capable of generating a different suction flow. The hole zones may correspond with one or more hole lanes extending parallel to each other in the movement direction and/or with one or more lateral hole zones. The size and/or shape and/or pattern of the holes and/or suction groups of one hole lane may be different from the size and/or shape and/or pattern of the holes and/or suction groups of another hole lane.

According to an exemplary embodiment, the media transport system further comprises at least one infeed means such as a roller or a robot arm configured to press the medium against the upper surface of the carrier. Instead of a roller or robot arm, also a slanted plate may be used to convert forward movement into downward force to press the medium to the carrier. In that manner the medium can be pressed firmly against the carrier before/during the activating of the valve means corresponding with the covered holes. Optionally, the infeed means may be configured to allow or reject a medium based on measurements by the measuring device. For example, the infeed means may be configured to reject a medium when e.g. the warp of the medium is too high.

According to a second aspect there is provided a printing apparatus comprising a media transport system according to any one of the previous embodiments, and one or more printheads, such as one or more inkjet printheads arranged opposite the carrier. It is noted that the term printhead may also refer to heads configured for applying a liquid different from ink, such as a primer or a coating liquid.

According to an exemplary embodiment, the printing apparatus may further comprise a control means configured for controlling a valve means in function of the distance between the valve means and the one or more printheads and/or in function of an operation state of the one or more printheads and/or in function of a speed of the print medium. For example, the valve means may be closed or may be opened less in the vicinity of an operational printhead. Also, before a medium moves between the carrier and a print bar with a plurality of print nozzles, the space between the print bar and the carrier is filled with air. A front edge of the medium, when moving underneath this print bar, will move a portion of this air in the movement direction. Especially for thicker media, the portion of air which is pushed forward may be significant. Evacuating this portion of air by a suitable control of the valve means may provide additional benefits and improve the printing result. More in particular, the timing of the activation of the valve means controlling holes before, underneath and after the print bar, may be adjusted to suitably evacuate at least a portion of the air which is pushed forward. Also, using slanted passages as described above may be advantageous in order to achieve a suitable evacuation which has no or limited impact on the operation of the print bar. More in particular, the passages may be configured to guide an air flow in the movement direction downwardly through the passages. Further, using multiple suction sources associated with multiple hole zones, as described above, may further enhance the control of the air flows around the medium. For example, the multiple hole zones may correspond with one or more lateral hole zones and/or one or more hole lanes extending in the movement direction. The size and/or shape and/or pattern of the holes and/or suction groups of one hole zone may be different from the size and/or shape and/or pattern of the holes and/or suction groups of another hole zone.

According to an exemplary embodiment, the printing apparatus may further comprise a control means configured for controlling each valve means such that the suction force exerted in a central zone of a print medium is different from the suction force exerted in an edge zone of the print medium. The controlling may be such that the suction force in the central zone is related to the suction force in the edge zone, and optionally they may be coupled. This may be useful to avoid that the friction between the moving medium and the carrier, or between a moving portion (e.g. a belt) of the carrier and a fixed portion of the carrier, is too high in certain areas, especially when the movement speed is high, e.g. 1 m/s or more. Indeed, holes covered by a medium will still be subject to air leaking in at a given flow. Typically, this leakage flow will be higher near the edges than in the centre of the medium. Too high suction pressures in the centre may increase the friction between the moving medium and the carrier, or between a moving portion (e.g. a belt) of the carrier and a fixed portion of the carrier, to a level that influences the speed of the forward motion, influencing printhead timings and thus printing quality. By controlling the valve means and/or the suction means the suction force can be regulated to be lower in certain areas than in other areas.

In an exemplary embodiment, the valve means may be controlled using a variable duty cycle. Thus the pressure is regulated by opening and closing a valve several times during passage of the same medium, e.g. a frequency between 10 Hz and 100 Hz, wherein the duty cycle, i.e. the percentage that the valve means is open, may be changed in function of the desired suction force.

Further, depending on the warp measured by the measuring device, the control of the valve means and/or suction means can be such that either the central zone is pulled with a lower suction force or the edge zone is pulled with a lower suction force. Indeed, convex or concave warping will require opposite control actions. Further, the infeed means may help to flatten the medium. Also, controlling the timing of the activation of the valve means and/or suction means may be done such that the warped medium is flattened or kept flat. Taking into account that the movement speed may be above 0.5 m/s, a variation in timing is a useful tool to regulate the total suction force onto the medium. It is noted that the suction force at a particular location of the medium may vary over time, and that the suction may even be interrupted, e.g. when the print medium passes below a printhead which is in operation. Even the volume of the chamber can be adjusted. In an embodiment where the valve means is controlled by duty cycling, a bigger volume of the chamber between valve means and the medium allows a more accurate pressure regulation by duty cycling of the valve means. In that manner the need for a separate suction source for a certain zone may be avoided. In exemplary embodiments the valve means may comprise flow regulators configured to operate by duty cycling, e.g. opening and closing with a frequency between 10 Hz and 100 Hz, and to regulate the flow by influencing the open and close time accordingly, i.e. by changing the duty cycle.

According to a third aspect there is provided a printing method comprising the steps of:
transporting a print medium on a carrier having a support surface with a plurality of holes;
moving at least a portion of the carrier with the print medium or moving the print medium relative to the carrier, in a movement direction, with a moving speed (v);
automatically allowing a suction flow through a subset of the plurality of holes, in function of a coverage area of the print medium on the upper surface;
printing an image on said print medium.

According to a possible embodiment, the step of automatically allowing a suction flow comprises automatically allowing a suction flow through a subset of the plurality of holes over which the print medium is present, whilst blocking a suction flow through other holes over which no print medium is present.

Preferably, the step of automatically allowing or blocking a suction flow is done by controlling a plurality of valve means.

According to a possible embodiment, the step of automatically allowing or blocking a suction flow is done by providing a plurality of valve means with activation means which protrude outward of the upper surface such that the valve means are opened for allowing a suction flow when a print medium is put on the upper surface and thus on the activation means.

According to another possible embodiment, each valve means is controlled in function of the moving speed and in function of a position of the print medium on the carrier.

Further developed embodiments may comprise detecting a curvature due to warping of the print medium, and controlling the suction flow through the plurality of holes in function of the detected curvature.

Also, the step of automatically allowing a suction flow may be done such that at least a portion of the air displaced by the moving of the medium, is evacuated through at least one hole of the plurality of holes, see also the fourth aspect of the invention which is described in detail below.

According to a fourth aspect of the invention there is provided a contact-less liquid application apparatus, and in particular a printing apparatus, for applying a liquid in a contact-less manner on a moving medium. The liquid application apparatus comprises: a liquid application means configured for applying a liquid on a moving medium; a media transport system configured for moving the medium in a movement direction at a distance of the liquid application means; a flow control means configured to evacuate at least a portion of the air displaced by the moving of the medium, at least before the medium is in a liquid application position, said liquid application position being a position in which the liquid application means is applying liquid on the medium.

In that manner, any disturbing air flows caused by the moving of the medium can be at least partially avoided. Indeed, when a medium is moved, in particular a thick medium such as cardboard, this may cause an airflow which will disturb the liquid that is being applied from a distance on the medium. Especially for printing application, such disturbances can significantly decrease the print quality as droplets will no longer be positioned at the correct location. By evacuating at least a portion of the air displaced by the moving of the medium, at least before the medium is in a liquid application position, such disturbance can be reduced or avoided.

Preferably, the flow control means is configured to evacuate at least a portion of the air displaced by the moving of the medium in a zone upstream of the liquid application means and/or between the liquid application means and the media transport system. The latter will be useful when the medium approaches the liquid application means, and, especially for a printing apparatus, this will improve the image quality in a zone bordering the front or leading edge of the medium. The removal in a zone upstream of the liquid application means can be done both when the medium approaches and when the medium is in a liquid application position opposite the liquid application means.

Preferably, the flow control means is configured to evacuate at least a portion of the air displaced by the moving of the medium in a zone before a front edge of the medium. Optionally, air is also evacuated in a zone behind a trailing edge of the medium and/or in a zone next to one or more side edges of the medium, and/or in a zone adjacent a surface of the medium (e.g. above the medium).

Preferably, the flow control means is configured to control the evacuation flow based on at least one of: the moving speed, a position of the medium on the media transport system, an operation state of the liquid application means. The liquid application apparatus may comprise a measuring device, such as a camera, a scanner, one or more sensors, configured for detecting a position of a front edge and/or a peripheral edge of the medium, wherein the flow control means is configured to control the evacuation flow based on the position detected by the measuring device. For example, the control flow means may be configured to generate a suction flow shortly before the front edge reaches an area opposite the liquid application means, and such that the suction flow is reduced or stopped when the liquid application means have started applying liquid onto the medium.

Preferably, the control flow means comprises at least one passage comprising: a passage located upstream of the liquid application means and having an inclination configured for guiding the suction flow away from a liquid application area; and/or a passage downstream of the liquid application means and having an inclination configured for guiding the suction flow away from a liquid application area.

Preferably, the liquid application means comprises one or more printheads, in particular one or more inkjet printheads.

Preferably, the flow control means comprises at least one suction means connected via at least one suction arrangement; and a controller configured for controlling the at least one suction arrangement and/or the at least one suction means such that at least a portion of the air displaced by the moving of the medium, is evacuated through the at least one hole. Such a suction arrangement may correspond with a suction group described above. It is possible that the suction arrangement is coupled with only one suction passage or with multiple suction passages. Optionally, the at least one suction arrangement comprises at least one valve means configured to regulate a suction flow in the at least one suction arrangement.

In an exemplary embodiment, the media transport system comprises a carrier having a support surface with at least one hole, said carrier being configured for supporting the medium on the support surface thereof; a drive means configured for moving at least a portion of the carrier with the medium or for moving the medium relative to the carrier, in the movement direction with a moving speed; wherein the flow control means is integrated in the media transport system and the at least one suction means is connected via at least one suction arrangement to the at least one hole. The shape of a hole may be substantially any one of the following or a combination thereof: round, rectangular, ring-shaped, oval, polygonal. The at least one hole may comprise more than 100 holes, wherein the distance between adjacent holes is between 1 mm and 400 mm, preferably between 4 mm and 400 mm. The carrier may be implemented according to any one of the embodiments described above, but may also be a different carrier. Also, the controller may be further configured according to any one of the embodiments described above.

The controller may be configured to control the at least one suction arrangements and/or the at least one suction means, such that the suction generated in an area where a medium is present is stronger than the suction generated in an area where no medium is present. In other words, preferably the suction force used for pulling the medium on the carrier is larger than the suction force used for generating the evacuation flow.

In an exemplary embodiment, the carrier is provided with at least one passage ending in the at least one hole in the support surface, wherein the at least one passage comprises one or more of: a passage located upstream of the liquid application means and having an inclination configured for guiding the suction flow along the support surface of the carrier away from a liquid application area; a passage downstream of the liquid application means and having an inclination configured for guiding the suction flow along the support surface of the carrier away from a liquid application area; a passage opposite the liquid application means. A passage may have a wall oriented at an angle smaller than 90 degrees with respect to the upper surface. For example, angles between 30 and 70 degrees may be used to create a suction flow which is not vertical w.r.t. the support surface.

In an exemplary embodiment, a hole of the plurality of holes may be ring shaped. A corresponding passage of the plurality of passages may then be conically ring-shaped.

The controller may be configured for controlling a valve means and/or a suction means in function of the distance between the valve means and/or the suction means and the liquid application means and/or in function of an operation state of the liquid application means.

The controller may be configured to control the at least one suction arrangement and/or the at least one suction means to exert a suction force through the at least one hole between a front edge of the medium and a liquid application area and/or in the liquid application area, before the front edge reaches this area.

In another exemplary embodiment, the flow control means is configured to deflect at least a portion of the air displaced by the moving of the medium, away from the media transport system, towards a zone upstream and/or downstream of the liquid application means. The flow control means may then be at least partially integrated in the liquid application means.

According to a fifth aspect of the invention, there is provided a liquid application method for applying a liquid in a contact-less manner on a moving medium. The method comprises the steps of: transporting a medium in a movement direction with a movement speed; evacuating at least a portion of the air displaced by the transporting of the medium, at least before the medium is in a liquid application position; applying liquid on said medium in a contact-less manner, when the medium has reached the liquid application position and whilst the medium is moving at the movement speed.

The transporting may be done on a carrier having a support surface with at least one hole; and the step of evacuating may comprise controlling a suction flow through the at least one hole such that at least a portion of the air displaced by the transporting of the medium, is evacuated through the at least one hole.

Preferably, the step of evacuating is done in a zone upstream of the liquid application means and/or between the liquid application means and the media transport system. The step of evacuating may be done in a zone before a front edge of the medium, and/or in a zone behind a trailing edge of the medium and/or in a zone next to one or more side edges of the medium, and/or adjacent a surface of the medium. The step of evacuating may be based on at least one of: the moving speed, a position of the medium, an operation state of liquid application means used for the step of applying liquid. For example, a suction flow may be generate shortly before the front edge reaches a liquid application area, and such that the suction flow is reduced or stopped when the applying of liquid onto the medium has started.

The liquid application method may comprise detecting a position of a front edge and/or of a peripheral edge of the medium, and controlling the step of evacuating taking into account the detected position.

The liquid application method may further comprise controlling a suction flow through at least one further hole above which the medium is present. This may be done according to any one of the control steps described above in connection with the first three aspects of the invention.

Preferably, the step of evacuating uses at least one suction means, optionally controlled by a valve means, for generating a suction flow for the evacuating of at least a portion of the air displaced by the transporting of the medium, and the step of evacuating comprises controlling the at least one valve means and/or the at least one suction means.

When the media transport system is used in a printing apparatus, with one or more printheads arranged opposite the carrier, preferably the control means is configured to control the plurality of valve means to exert a suction force through the at least one hole, preferably in a zone before of the front edge and/or behind the trailing edge and/or next to one or more side edges between the front edge and the trailing edge, at least shortly before the front edge of the medium passes below the one or more printheads. More in particular, a suction force may be exerted through at least one hole in a zone upstream of the printhead and/or in a zone underneath a printhead shortly before the applying of liquid by the one or more printheads on the medium, and preferably before the front edge is underneath the one or more printheads.

In embodiments where the medium is moved relative to the carrier and where the holes are static, a suction force may be exerted through at least one hole underneath a printhead shortly before the front edge reaches this at least one hole. At that point in time the suction force is used to evacuate the air flow caused by the moving of the print medium. Once the front edge has passed underneath the printhead, the suction force through this at least one hole can be used to pull the medium to the carrier.

In embodiments where the medium and a portion of the carrier (such as a belt or table with the plurality of holes arranged therein) is moved relative to a static support and where the holes are moving together with the medium, a suction force may be exerted through at least one hole upstream of the front edge shortly before the front edge passes underneath the printhead and before the applying of liquid by the printhead, and the suction action may be stopped or reduced when the printing operation has started.

Preferred features set out above for the first and second aspect, may also apply for the fourth and fifth aspect, where applicable.

According to other embodiments of the invention, the media transport system may have the features of any one of the following clauses:

1. A media transport system, in particular for use in a printing apparatus, said media transport systems comprising: a carrier (100, 200) having a support surface (101) with a plurality of holes (110), said carrier being configured for supporting a medium, typically a print medium (M, M1, M2) on the support surface thereof; a drive means configured for moving at least a portion of the carrier (100, 200) with the medium or for moving the medium relative to the carrier (100, 200), in a movement direction with a moving speed (v); a plurality of suction groups (250) between the plurality of holes (110) and at least one suction means (300); for each suction group (250), at least one valve means (260, 270, 280) operable to allow or interrupt a suction flow through one or more holes of the plurality of holes; each at least one valve means being configured or controlled such that automatically a suction force is exerted through said one or more holes in function of a coverage area of the medium on the support surface.

2. The media transport system of clause 1, wherein each at least one valve means is configured or controlled such that automatically a suction force is exerted on the medium when a medium is present over the at least one hole associated with the corresponding suction group, and such that no suction force is exerted through said at least one hole when no medium is present over said at least one hole.

3. The media transport system of clause 1 or 2, wherein the drive means is configured for moving at least the support surface of the carrier (100, 200) with the medium.

4. The media transport system of the previous clause, wherein the carrier (100, 200) comprises a movable plate (100) with the plurality of holes (110) and a static support structure (200), and wherein the drive means is configured to move the plate (100).

5. The media transport system of the previous clause, wherein the plurality of suction groups (250) extend in the static support structure (200) and the valve means (260) are arranged in the static support structure (200).

6. The media transport system of the previous clause, further comprising a controller (400) configured for controlling each valve means (260) in function of the moving speed and in function of a position of the medium on the movable plate.

7. The media transport system of clause 3, wherein the drive means is configured for moving the entire carrier (100, 200) including the valve means.

8. The media transport system of clause 1 or 2, wherein the drive means is configured for moving the medium (M) relative to the carrier (100, 200).

9. The transport medium of the previous clause, wherein the at least one valve means (270) comprise one or more closure bodies associated with the one or more holes, each closure body being configured and arranged for blocking a fluid passage through a hole when no medium is present over said hole and for allowing a fluid passage through said hole when a medium is present over said hole.

10. The media transport system of clause 4, wherein the valve means (280) are arranged in the movable plate (100) and configured for blocking a fluid passage through a hole when no medium is present over said hole and for allowing a fluid passage through said hole when a medium is present over said hole.

11. The media transport system of clause 8, wherein the carrier comprises a plate (100) provided with the plurality of holes (110) and a support structure (200), and wherein the valve means (260) is arranged in the support structure (200).

12. The media transport system of the previous clause, further comprising a controller (400) configured for controlling each valve means (260) in function of the moving speed (v) and in function of a position of the medium (M) on the carrier (100, 200).

13. The media transport system of any one of the previous clauses, wherein the carrier (100, 200) comprises a belt and/or a table and/or a roller.

14. The media transport system of any one of the previous clauses, wherein the plurality of holes (110) is such that in operation multiple holes are coupled with a suction group.

15. The media transport system of any one of the previous clauses, wherein the shape of a hole of the plurality of holes is substantially any one of the following or a combination thereof: round, rectangular, ring-shaped, oval, polygonal.

16. The media transport system of clause 6 or 12, further comprising a measuring device, such as a camera, a scanner, one or more sensors, configured for detecting a position of the medium on the carrier, wherein the controller is configured to control the valve means in function of the position detected by the measuring device.

17. The media transport system of clause 6 or 12, further comprising a mechanical detection system arranged in said carrier for detecting a position of the medium on the carrier, wherein the controller is configured to control the valve means in function of the position detected by the mechanical detection system.

18. The media transport system of clause 6 or 12, further comprising a measuring device configured for detecting warping of the medium, wherein the controller is configured to control the valve means and/or to control the at least one suction means in function of the detected warping by the measuring device.

19. The media transport system of any one of the previous clauses, wherein the carrier is provided with a plurality of passages ending in the plurality of holes in the support surface, wherein a passage of the plurality of passages has a wall oriented at an angle smaller than 90 degrees with respect to the support surface.

20. The media transport system of the previous clause, wherein a hole of the plurality of holes is ring shaped and a corresponding passage of the plurality of passages is conically ring-shaped.

21. The media transport system of any one of the previous clauses, wherein the plurality of holes comprises more than 100 holes, wherein the distance between adjacent holes is between 1 mm and 400 mm, preferably between 4 mm and 400 mm.

22. The media transport system of any one of the previous clauses, further comprising at least one infeed means configured to press the medium against the support surface of the carrier.

23. The media transport system of any one of the previous clauses, further comprising a control means configured for controlling the plurality of valve means such that at least a portion of the air displaced by the moving of the medium, is evacuated through at least one of the plurality of holes.

24. A printing apparatus comprising a media transport system according to any one of the previous clauses, and one or more printheads configured for contactless printing, and in particular one or more inkjet printheads, arranged opposite the carrier.

25. The printing apparatus of the previous clause, further comprising a control means configured for controlling a valve means (260) in function of the distance between said valve means and the one or more printheads and/or in function of an operation state of the one or more printheads and/or in function of a speed of the print medium (M).

26. The printing apparatus of clause 24 or 25, further comprising a control means configured for controlling each valve means (260) such that the suction force exerted in a central zone of a print medium is different from the suction force exerted in an edge zone of the print medium.

27. The printing apparatus of any one of the clauses 24-26, comprising a media transport system according to clause 23, wherein the control means is configured to control the plurality of valve means to exert a suction force through the at least one hole before the front edge of the medium passes opposite the one or more printheads.

28. A printing method comprising the steps of: transporting a print medium (M, M1, M2) on a carrier (100, 200) having a support surface (101) with a plurality of holes (110); moving at least a portion of the carrier with the print medium or moving the print medium relative to the carrier, in a movement direction, with a moving speed (v); automatically allowing a suction flow through a subset of the plurality of holes in function of a coverage area of the print medium on the support surface; printing an image on said print medium.

29. The printing method of clause 28, wherein automatically allowing a suction flow comprises automatically allowing a suction flow through a subset of the plurality of holes over which the print medium is present, whilst blocking a suction flow or applying a reduced suction flow through other holes over which no print medium is present.

30. The printing method of clause 28 or 29, wherein the step of automatically allowing a suction flow is done by controlling a plurality of valve means.

31. The printing method of any one of the clauses 28-29, the step of automatically allowing a suction flow is done by providing a plurality of valve means with activation means which protrude outward of the support surface such that the valve means are opened for allowing a suction flow when a print medium is put on the support surface and thus on the activation means.

32. The printing method of any one of the clauses 28-30, wherein each valve means (260) is controlled in function of the moving speed and in function of a position of the print medium on the carrier.

33. The printing method of any one of the clauses 28-32, further comprising detecting a curvature due to warping of the print medium, and controlling the suction flow through the plurality of holes in function of the detected curvature.

34. The printing method of any one of the clauses 28-33, wherein the step of automatically allowing a suction flow is done such that at least a portion of the air displaced by the moving of the medium, is evacuated through at least one hole of the plurality of holes.

### BRIEF DESCRIPTION OF THE FIGURES

The accompanying drawings are used to illustrate presently preferred non-limiting exemplary embodiments of the present invention. The above and other advantages of the features and objects of the invention will become more apparent and the invention will be better understood from the following detailed description when read in conjunction with the accompanying drawings, in which:

FIG. 1A is a schematic exploded view of an exemplary embodiment of a media transport system, in particular for use in a printing apparatus;

FIG. 1B is a schematic cross section of the exemplary embodiment of FIG. 1A;

FIG. 1C is a schematic exploded view of another exemplary embodiment of a media transport system, in particular for use in a printing apparatus;

FIG. 1D is a schematic cross section of the exemplary embodiment of FIG. 1C;

FIG. 2 is a schematic top view of an exemplary embodiment illustrating an upper surface of a carrier on which a plurality of print media is arranged;

FIGS. 3A and 3B are schematic cross-sectional views of an exemplary embodiment of a carrier with a valve means, in a closed position and in an open position, respectively;

FIGS. 4A and 4B are schematic cross-sectional views of an exemplary embodiment of a carrier with valve means in an open position and in a closed position, respectively;

FIG. 5 is a cross-sectional view of an exemplary embodiment of a carrier with a conical passage;

FIG. 6 is a cross-sectional view of an exemplary embodiment of a printing apparatus comprising the media transport system;

FIGS. 7A and 7B are schematic cross-sectional views of an exemplary embodiment of a carrier with an integrated valve means in a closed and open position, respectively;

FIG. 7C is a top view of the valve means of FIGS. 7A and 7B;

FIGS. 8A-E illustrate another exemplary embodiment of a carrier with an integrated valve means with in FIG. 8A a schematic section A-A in the closed position of the valve means, in FIG. 8B a schematic section B-B, in FIG. 8C a schematic top view indicating A-A and B-B for a round variant, in FIG. 8D a schematic top view indicating A-A and B-B for a rectangular variant, and in FIG. 8E a schematic section A-A in the open position of the valve means;

FIG. 9 illustrates a schematic perspective view of another exemplary embodiment of a printing apparatus with a media transport system; and FIGS. 9A and 9B illustrate cross sections of possible implementations of details the media transport system of FIG. 9;

FIG. 10A illustrates a cross section of another exemplary embodiment of a printing apparatus with a media transport system, and FIG. 10B illustrates a schematic top view thereof; and

FIGS. 11-13 illustrate schematic cross sectional views of further exemplary embodiments of a liquid application apparatus.

### DESCRIPTION OF EMBODIMENTS

The figures are not drawn to scale and purely diagrammatical in nature. Equal reference numerals in different figures refer to equal or corresponding features.

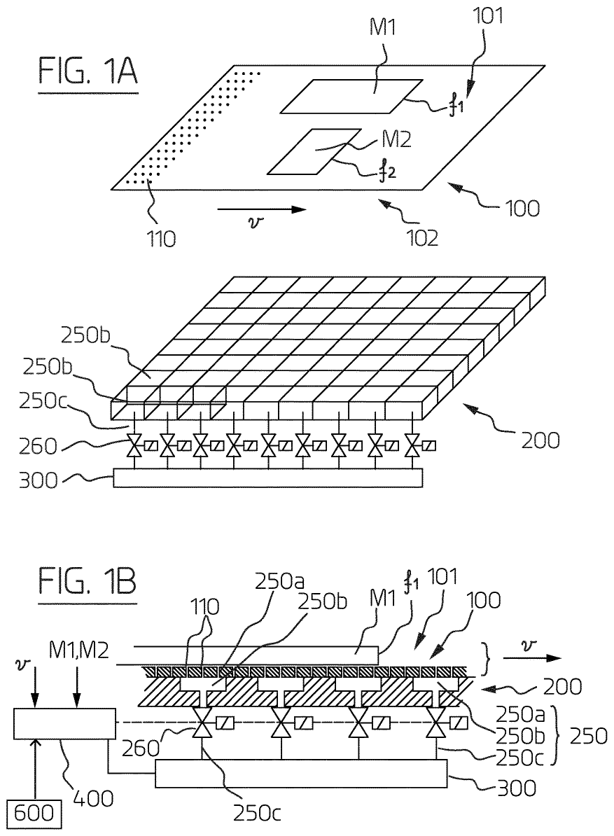

FIGS. 1A and 1B illustrate a media transport system, in particular for use in a printing apparatus. The media transport system comprises a carrier 100, 200 having a support surface, here an upper surface 101 with a plurality of holes 110. The carrier is configured to support a print medium M1, M2 on the upper surface 101 of the carrier 100, 200. A drive means (not shown) is configured for moving a portion, here a movable plate 100 of the carrier 100, 200 in a movement direction v, such that a print medium M1, M2 arranged thereon will also be moved in the movement direction v. The drive means may be configured to move the plate 100 and thus the medium M1, M2 at a speed of more than 0.5 m/s, preferably more than 1 m/s.

The plurality of holes 110 may be arranged according to a repetitive and/or regular pattern or may be positioned in an irregular and/or random manner. The holes 110 may be arranged, for example, in rows and columns as illustrated in FIG. 1A. However, the skilled person understands that many patterns are possible, and that the pattern may be adjusted depending on the type of media used and/or in function of the type of operation that has to be performed on the media whilst being transported by the media transport system.

In the exemplary embodiment of FIGS. 1A and 1B the carrier comprises a movable plate 100 with an upper surface 101 in which the plurality of holes 110 is arranged and a static support structure 200 for supporting the movable plate 100. The carrier 100, 200 comprises a plurality of suction groups 250 between the plurality of holes 110 and a suction means 300. In the illustrated embodiment each suction group 250 extends between six holes 110 and the suction means 300. Each suction group 250 comprises two rows of three passages 250a (associated with the six holes 110) through the movable plate 100, a suction chamber 250b in the support structure 200 and a suction line 250c in which a valve means 260 is included. For each operative position of the movable plate 100, the suction chamber 250b is, at an upper end thereof, in fluid communication with six passages 250a of the movable plate 100, and at a lower end thereof with the suction line 250c. The valve means 260 is operable to allow or interrupt the suction flow through the associated suction group 250, and in particular through the six holes 110 of the associated suction group 250. In the illustrated embodiment each suction group is associated with six holes 110, but the skilled person understands that each group 250 may be associated with less then six, e.g. one or two holes, or more than six holes.

Each valve means 260 may be controlled by a controller 400 such that automatically a suction force is exerted on a print medium M1, M2 present over the holes 110 associated with the suction group 250, and such that no suction force is exerted through the holes 110 associated with the suction group 250 when no print medium M1, M2 is present over said holes 110. When the valve means 260 is in an open position, the holes 110 of the associated suction group 250 are connected to the suction source 300, e.g. a vacuum source, such that the print medium M1, M2 is exposed to a suction force and is pulled to the upper surface 101 of the movable plate 100. The suction means 300 may comprise a vacuum pump or similar. It will be clear to the skilled person that the valve means 260 may also control the strength of the suction force exerted on the print medium M1, M2 by controlling the air flow through the valve means 260. For example, the valve means 260 may be controlled by using a variable duty cycle. The valve means 260 may be electrically controlled by the controller 400. Further developed embodiments may further adjust the suction flows caused by the valve means 260 based also on other parameters than the area covered by the medium. Also, in further developed embodiments, a suction flow through some of the non-covered holes 110 may be generated for other purposes, for example to evacuate any disturbing air flows, such as air flows caused by the movement of the medium, see further. It is noted that not all holes covered by a printing medium M1, M2 have to be in fluid communication with the suction means 300, and that in certain cases it may be sufficient to cause a suction force through only a subset of the covered holes, e.g. the holes near the edges of the medium M1, M2 and some holes in a centre of the medium M1, M2.

In order to be able to automatically control the valve means 260, the controller may receive input data representative for an initial position of a print medium M1, M2 on the movable plate 100 and of the moving speed v of the movable plate 100. Based on this input information, the valve means 260 can be controlled in function of time, such that at a specific moment in time only those suction groups 250 associated with the holes 110 below the print medium are activated. In other words, for the example of FIG. 1 where the print medium M1, M2 moves from left to right in function of time, the set of activated groups 250 will also move from left to right in function of time. In order to determine the position of the print medium on the movable plate 100, the media transport system may comprise a measuring device 600, such as a camera, a line scanner, a laser distance sensor, configured for detecting a position of the print medium on the movable plate 100. The controller 400 is configured to control the valve means 260 in function of the position detected by the measuring device 600. In other words the controller 400 may only open the valve means 260 where a print medium M1, M2 is arranged on the movable plate 100. Alternatively, a mechanical detection system (not shown) may be arranged in the carrier 100, 200 for detecting the position of the print medium M1, M2 on the carrier. The controller 400 may then be configured to control the valve means 260 in function of the position detected by the mechanical detection system. The controller 400 may further be configured to control the valve means 260 in function of a curvature detected by a sensor means (not shown) which is configured for detecting a curvature due to warping of the print medium M1, M2. By controlling the valve means 260 based on a detected curvature the fixation of the print medium M1, M2, and hence the printing quality may be improved.

Optionally, the controller 400 may further be configured to control the suction means 300. Also, optionally, the controller 400 may be configured to control the moving speed v of the movable plate 100, and thus of the print medium M1, M2 supported thereon. It is noted that the controller 400 may be implemented as a single control unit or as a plurality of separate control units.

In the embodiment of FIGS. 1A and 1B the plurality of suction groups 250 are associated with a single suction means 300, e.g. a single vacuum source, and the multiple valve means 260 control the multiple suction flows. For example, the valve means 260 may be controlled to be more or less open in function of the distance to an edge of the medium M, the distance from a front edge f1, f2 of the medium M, etc. Also, the timing may be controlled, e.g. in function of warp-related measures.

FIGS. 1C and 1D illustrate a variant of the embodiment of FIGS. 1A and 1B in which similar components have been indicated with the same reference numerals. Multiple suction means 300 (S1, S2, S3) are provided, e.g. in the form of multiple vacuum sources 300, which may be set or controlled independently of each other. The multiple suction sources 300 are associated with multiple hole zones Z1, Z2, Z3. The hole zones Z1, Z2, Z3 may correspond with lateral zones extending in a lateral direction perpendicular on the movement direction. In that manner, different suction strengths/pressures may be set in function of the location of the print medium M1, M2 with respect to the support structure 200. For example, the strength may be adjusted in an area where a printhead is present above the support structure 200. In other embodiments (not shown in FIGS. 1C and 1D), the hole zones may correspond with hole lanes extending in the movement direction, or with a combination of one or more hole lanes and one or more lateral hole zones. For example, a suction pressure of the suction source for a hole lane covered by a medium where the medium has a high warp height may be higher than a suction pressure of the suction source for another hole lane with a lower warp height. Also, the size and/or shape of the holes 110 and/or of the suction groups 250 of one hole zone may be different from the size and/or shape of the holes 110 and/or of the suction groups 250 of another hole zone.

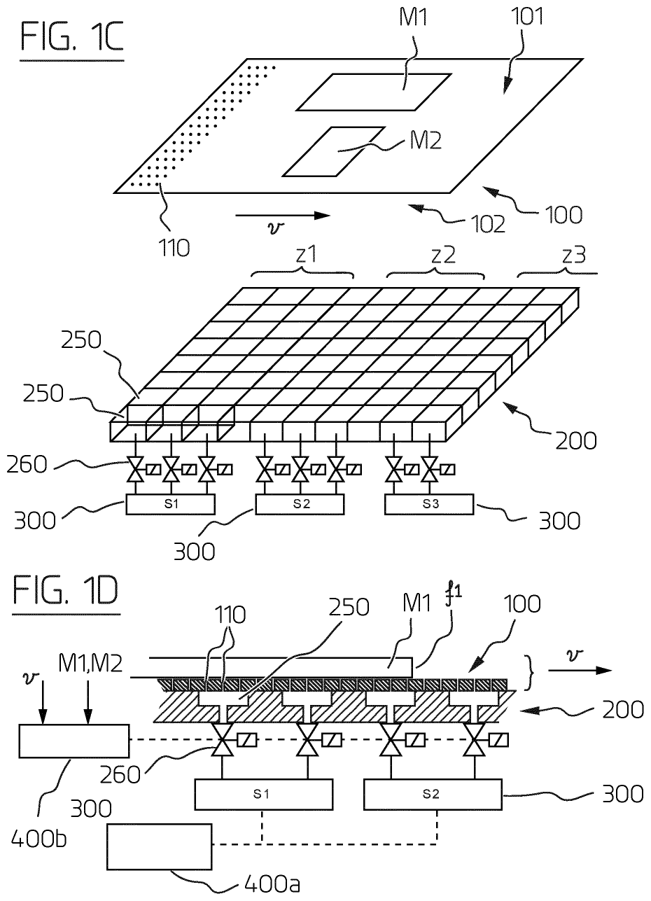

FIG. 2 illustrates a top view of the carrier 100 wherein a plurality of holes 110 is arranged in an upper surface 101 thereof. A plurality of print media M1, M2 are shown to be arranged on the surface of the carrier 100 and move in a moving direction with a moving speed v. The print media M1, M2 are shown to cover a plurality of holes 110. The distance d1, d2 between adjacent holes may be between 4 mm and 400 mm. The lateral distance d1 measured in a direction perpendicular on the movement direction v and a longitudinal distance d2 measured in the movement direction v may differ depending on the pattern and the required accuracy on the lateral and longitudinal direction. Also, the distance d1, d2 does not have to be the same over the entire surface of the movable plate 100, and may vary in the between different rows or columns of holes 110. For example, the hole density may be higher at the edges than in the center of the plate 100 or vice versa. Also, holes 110 may be arranged according to a diagonal pattern. This may improve the distribution of the holes 110 and may improve the overall grip on the medium M1, M2 arranged on the carrier 100.

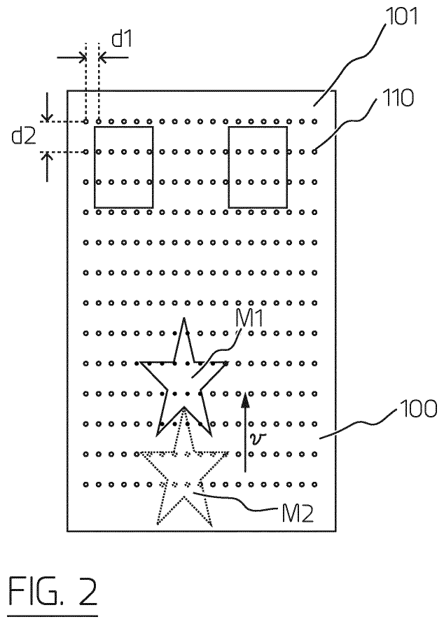

FIGS. 3A and 3B illustrate a cross-sectional view of another exemplary embodiment of a carrier 100, 200 with a valve means 270. The valve means 270 is shown in a closed position in FIG. 3A and in an open position in FIG. 3B. The valve means 270 is shown to be arranged in the carrier between a static upper plate 100 and a static lower support structure 200. The upper plate 100 is provided with a plurality of holes 110. Each hole is associated with a valve means 270. The valve means 270 comprises a closure body 270, in the example of FIGS. 3A and 3B shaped as a sphere with a protruding portion configured to protrude through the associated hole 110 when no print medium is present. The closure body 275 is carried by a spring means 276 configured for exerting a spring force on the closure body 275 in the direction of the hole 110. Each closure body 275 is configured and arranged for blocking a fluid passage through the associated hole 110 when no print medium is present above said hole 110. The closure body 275 is further configured to allow a fluid passage through the hole 110 when a print medium M is present above said hole 110. When no print medium M is present above the hole 110, the valve means 270 is in the closed position, see FIG. 3A. When the print medium M is moved relative to the carrier 100, 200 in a movement direction with a moving speed v, to a position where the print medium M is present above the hole 110, the print medium pushes the closure body 275 downwards such that the valve means 270 is moved to the open position 110, see FIG. 3B. In this position the hole 110 is in fluid communication with a suction means 300 via a suction group 250 consisting of a passage 250a through the plate 100 and a suction chamber 250b underneath the plate 100, between the plate 100 and a suction means 300. The print media M is thereby exposed to a suction force. Thus, the valve means 270 is configured such that automatically a suction force is exerted on the print medium, when the print medium M is present above the hole associated with the valve means 270. When the print medium is moved away from the hole 110, the spring means 276 will position the closure body 275 back in the closed position, see FIG. 3A. The closure body 275 may be of any suitable form, as is further illustrated in the following exemplary embodiments.

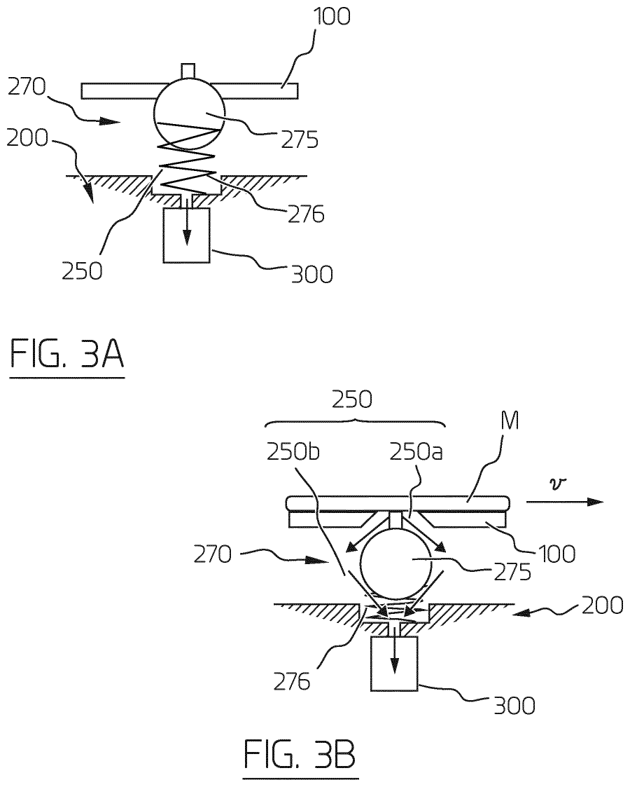

FIGS. 4A and 4B illustrate cross-sectional views of another exemplary embodiment of a carrier 100, 200 comprising a valve means 280. In FIGS. 4A and 4B, the carrier comprises a movable plate 100 with a plurality of holes 110 and a static support structure 200. Each hole 110 id provided with a valve means 280 which is integrated in the movable plate 100 and configured for blocking a fluid passage through the hole 110 when no print medium is present above said hole 110a, and for allowing a fluid passage through said hole 110 when the print medium is present above said hole. While FIGS. 4A and 4B illustrate a mechanical valve means 280 integrated in the movable plate 100, the static support structure 200 or the movable plate 100 may alternatively comprise electrically controlled valve means. In this case a controller (not shown) may be configured for controlling each valve means in function of the moving speed and in function of the position of the print medium M on the carrier 100, 200, similar to the embodiment of FIGS. 1A and 1B. In yet another embodiment, instead of using a mechanical valve means 280 which is activated by the weight of the print medium, the valve means 280 may be electrically controlled by a sensor, e.g. a distance sensor, sensing the presence of a print medium above the hole

The valve means 280 of FIGS. 4A and 4B has a piston-like closure body 285, and is arranged in a passage 250a connecting the hole 110 in the upper surface 101 with a suction chamber 250b in the static support structure 200. Passage 250a and suction chamber 250b form a suction group 250 between the hole 110 and the suction means 300. The closure body 285 of the valve means 280 comprises an upper section 281 protruding out of the upper surface 101 of the movable plate 100, when no print medium M is present above the associated hole 110, and a lower section 282 having a flange portion intended to abut against an abutment surface 255 in the passage 250a through the plate 100. The lower section 282 can be arranged in sealing engagement with the abutment surface 255 by a spring means 286, such that substantially no leakage is allowed through the hole 110, when no print medium M is present above the hole. When the print medium is arranged above the hole 110, as is illustrated in FIG. 4B, the piston-like closure body 285 is pushed down such that the seal is broken and airflow is permitted through the hole 110 such that a suction force is exerted on the print medium M. In similar fashion as illustrated in FIG. 3, the spring means 286 pushes the piston-like closure body 285 back into the closed position when the print medium is no longer present above the hole. The term sealing refers to the sealing of the hole 110 such that no air flow is permitted. In other words, the hole is closed. To that end, a sealing material may be arranged in the sealing area, for example a seal fabricated from rubber. This further reduces the leakage rate, thereby reducing the energy consumption of the media transport system.

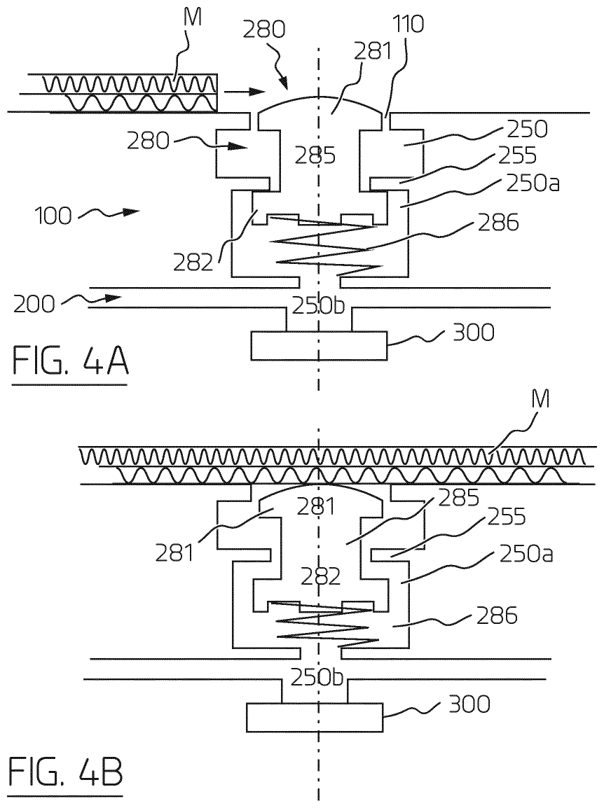

FIG. 5 illustrates yet another embodiment of a static carrier 100, 200 supporting a print medium M which is moved with a movement speed v along the carrier 100, 200. The carrier comprises a plate 100 with an upper surface 101 in which a plurality of holes 110 are arranged. The plate 100 is provided with a plurality of passages 250 between the plurality of holes 110 in the upper surface 101 and a rear surface 102. The passage 250 has a wall oriented at an angle a smaller than 90 degrees with respect to the upper surface 101. More in particular, the hole 110 may be ring shaped and the corresponding passage 250 may comprise a conically ring-shaped wall portion 251. Optionally the conically ring-shaped wall portion 251 may merge into a cylindrical portion 252. Optionally a central body 255, here a conical body, may be arranged in the passage 250. The lower end of the passage 250 is connected to a valve means 260 which may be controlled by a controller 400 in a similar manner as described above in connection with FIGS. 1A and 1B. Such an embodiment has the advantage that the suction flow is not oriented perpendicular on the upper surface 101. Especially in areas where nozzles, such as inkjet nozzles are arranged above the print medium, it is advantageous to avoid air flows in the zone where ink is being deposited on the print medium. FIGS. 5A and 5B illustrate two other possible variants of the embodiment of FIG. 5 where the passage 250 has a wall oriented at an angle a smaller than 90 degrees with respect to the upper surface 101. In the embodiment of FIGS. 5A and 5B the passage 250 has a wall extending at an angle a with respect to the upper surface 101 which is below 60°. In the embodiment of FIG. 5A the passage 250 may be e.g. cylindrical or prism shaped with an axis making an angle a with the upper surface. In the embodiment of FIG. 5B the passage 250 has a curved wall allowing to further reduce the angle a.

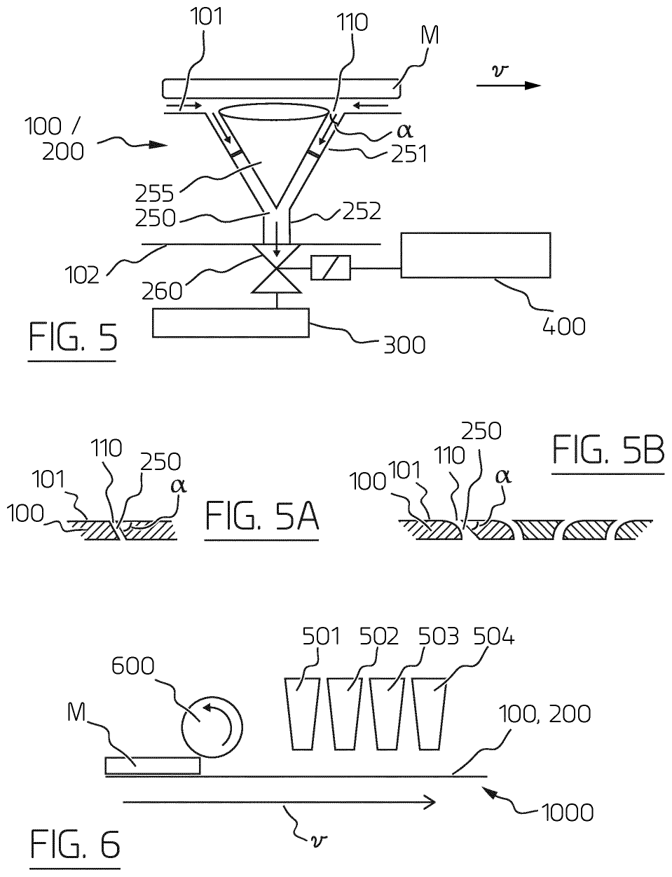

FIG. 6 is a schematic representation of an exemplary embodiment of a printing apparatus comprising a media transport system 1000 according to any one of the embodiments disclosed above, and a plurality of printheads, such as inkjet printheads 501, 502, 503, 504 arranged above the carrier 100, 200 of the media transport system 1000. The printing apparatus further comprises an infeed means 600, e.g. a roller, configured to press the print medium M against the upper surface of the carrier 100, 200. Optionally a control means may be provided configured for controlling the valve means (not shown in FIG. 6, but may be implemented as described above) of the media transport system 1000 in function of the distance between a hole associated with said valve means and the one or more printheads 501, 502, 503, 504 and/or in function of an operation state of the one or more printheads 501, 502, 503, 504 and/or in function of a speed v of the print medium (M). Such control means may be part of the controller 400 illustrated in FIGS. 1A and 1B, or may be a separate control means. For example, the suction force may be lower for the holes immediately below the printheads 501, 502, 503, 504, in order to avoid that the path of the liquid (e.g. ink) which is applied (e.g. jetted) by printheads 501, 502, 503, 504 is influenced by the suction flow. Also, optionally there may be provided a control means configured for controlling the valve means such that the suction force exerted in a central zone of a print medium is different from the suction force exerted in an edge zone of the print medium.

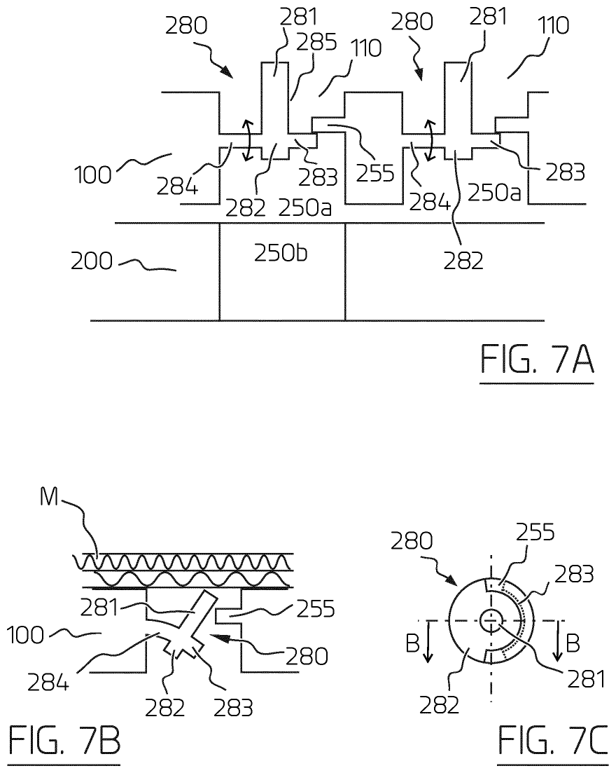

FIGS. 7A-C illustrate an alternative embodiment of a carrier 100, 200 with a valve means which is integrated in the carrier 100, 200. The embodiment is similar to the embodiment of FIG. 5, with this difference that the valve means are made in one piece with the movable plate 100 of the carrier. To that end, the movable plate 100 may be fabricated entirely from a resilient material or may comprise valve means arranged in the movable plate which are fabricated from resilient material. In similar fashion as previously described, the suction groups 250 may comprise passages 250a through the plate 100 and suction chambers 250b in the static support structure 200, which are connected to the suction means 300. The valve means 280 are integrally formed with the movable plate 100 with an upper portion 281 of the valve means 280 extending beyond the upper surface of the movable plate 100 in the closed rest position of the vale means 280. The valve means 280 has a lower portion 282 with a bendable part 284 connected to a wall part of the passage 250a, and with a flange 283 intended to be in contact with an abutment surface 255 protruding out of the wall of the passage 250a in the closed position of the valve means 280, see FIG. 7A. When the print medium M is present above the hole 110, as shown in FIG. 7B, the closure body 285 of the valve means 280 is bent inwardly such that the seal formed by the flange 283 and the abutment surface 255 is broken and a suction force is exerted on the print medium M. When the print medium is no longer present above the hole 110, the bendable part 284 which is made from the resilient material will bend back into the sealed position. FIG. 7C illustrates a top view of an integrated valve means 280 wherein the flange 283 is shown to extend beyond the abutment surface 255 arranged in the passage 250a, thereby forming a seal.

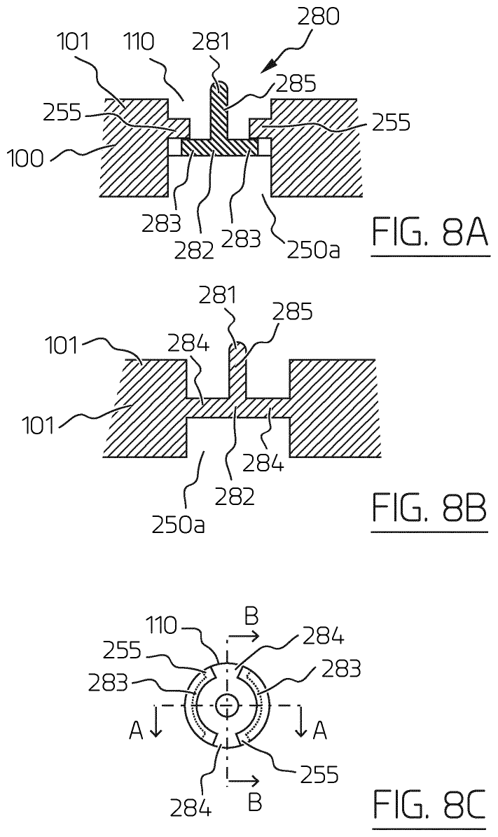

FIGS. 8A-8D illustrate yet another exemplary embodiment of a carrier with a plate 100 with an integrated valve means 280, which is similar to the embodiment of FIGS. 7A-7C with this difference that the lower portion 282 is provided with two sealing flanges 283 and two bendable connecting parts 284 on opposite sides of the closure body 285. As illustrated in FIGS. 8C and 8D, the closure body 285 may be embodied as a round variant (FIG. 8C) arranged in a cylindrical passage 250a or as a rectangular variant (FIG. 8D) arranged in a prism shaped passage 250a. FIG. 8E illustrates the integrated valve means 280 in an open position where the two seal flanges 283 are moved away from the two abutment surfaces 255 protruding out of a wall of the passage 250a.

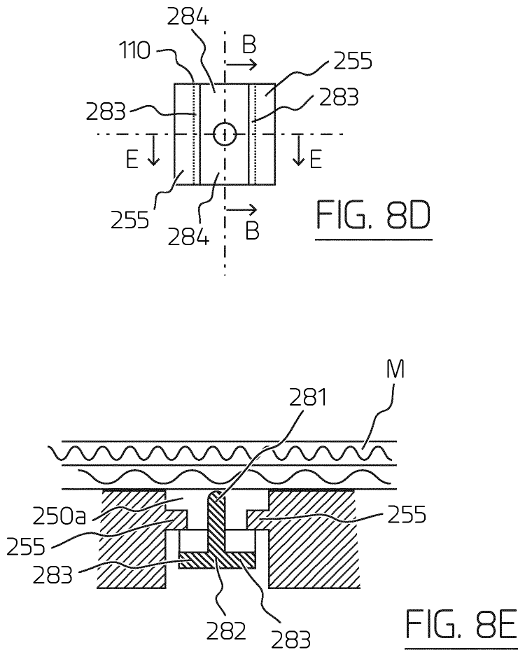

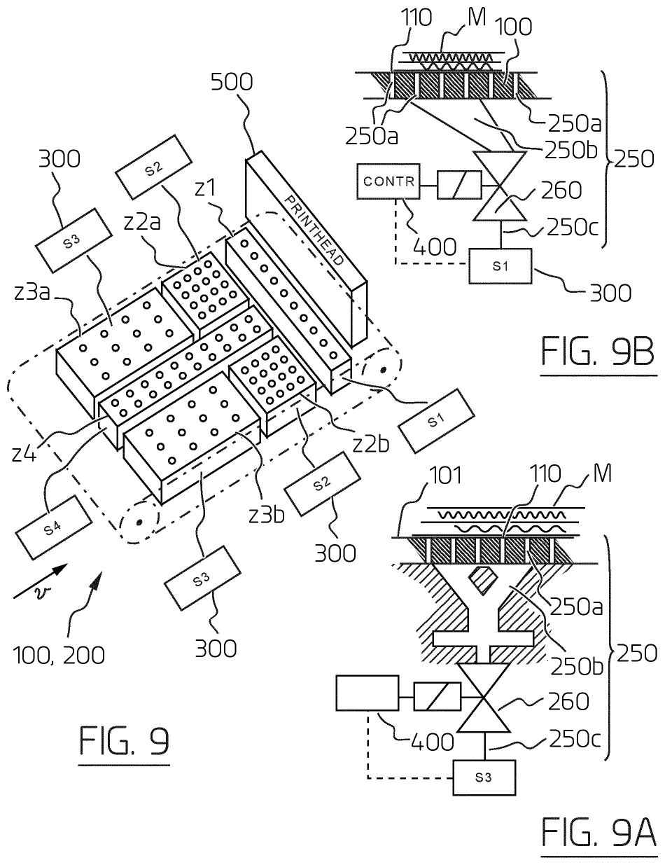

FIG. 9 illustrates a further developed embodiment of a printing apparatus with a media transport system having multiple holes zones. Similar components have been indicated with the same reference numerals as in the previous embodiments. The plurality of holes 110 are arranged in different hole zones Z1, Z2a, Z2b, Z3a, Z3b, Z4. As illustrated in FIGS. 9A and 9B, the holes 110 and the corresponding suction groups 250 of a different hole zone may have a different shape and/or size and/or may be associated with a different suction means S1, S2, S3, S4 in order to obtain different suction flows. The size and/or shape of the holes 110 and/or suction groups 250 of one hole zone may be different from the size and/or shape of the holes 110 and/or suction groups 250 of another hole zone. The hole zone Z4 corresponds with a central hole lane extending in the movement direction v, and the hole zone Z1 corresponds with a lateral hole zone extending perpendicular on the movement direction v. Further holes zones Z2a, Z2b, Z3a, Z3b extend on either side of the central hole lane Z4. Hole zone Z1 which is arranged upstream and/or underneath the printhead may be used for evacuating an air flow caused by the movement of the print medium M as will be further explained in connection with FIG. 10. Holes zones Z2a, Z2b, Z3a, Z3b, Z4 may be controlled independently e.g. in function of a type of warping, a location of the medium on the carrier 100, 200, etc. For example, when a medium covers both zones Z3a, Z3b and Z4, the suction force exerted in Z4 may be lower than in zone Z3a, Z3b in order to avoid that the friction between the medium and the carrier is too higher and/or in order to compensate for warping at the edges of the medium.

FIGS. 10A and 10B illustrate yet another exemplary embodiment of a liquid application apparatus, here a printing apparatus with a media transport system and a flow control means 2000 configured to evacuate at least a portion of the air displaced by the moving of the medium. The media transport systems comprises a carrier 100, 200 having an upper surface 101 with a plurality of holes 110 (in FIGS. 10A and 10B only the holes near the printhead 500 are shown but it will be understood that more holes may be present, and the holes may be implemented in any suitable way described above). The carrier 100, 200 is configured for supporting a print medium M on the upper surface 101 thereof. In the embodiment of FIG. 10A, a drive means (not illustrated) may be configured either to move a belt or table 100 with holes 110 relative to a static support structure 200 as in the embodiment of FIGS. 1A-1D, or to move the print medium M relative to the carrier 100, 200, as in the embodiment of FIG. 5. The print medium M is moved in a movement direction with a moving speed v.

The flow control means 2000 comprises at least one suction means 300 connected via a plurality of suction arrangements 250. The plurality of suction groups or arrangements 250 is present between the plurality of holes 110 and the at least one suction means 300 (here as an example two suction means S1 and S2 are shown). The plurality of suction groups 250 comprises a corresponding plurality of valve means 260 operable to allow or interrupt a suction flow through one or more holes 110. The plurality of valve means 260 is controlled by a control means 400b configured for controlling the plurality of valve means 260 such that at least portion of the air displaced by the moving of the medium M, is evacuated through at least one hole of the plurality of holes 110 in a zone Z1 before of a front edge f of the medium M, and upstream of the printhead. Also, at least one further hole 110 may be provided in a zone Z2 downstream of the printhead 500. In that manner, any air flows disturbing the printing can be at least partially avoided. In other words, holes 110 may not only be used to pull the medium M onto the carrier 100, 200, but also to evacuate an air flow around the medium M, such that disturbing air flows underneath the printhead are avoided.

In the illustrated example, the medium may be cardboard and have a thickness B between e.g. 0.5 mm and 10 mm. The thickness A of the air flow above the medium may be e.g. 5 mm to 20 mm. The distance C between the carrier and the printhead may be 0.5 mm to 2 mm more than the thickness B of the cardboard.

One or more printheads 500 are arranged above the carrier 100, 200. The control means 400a may be further configured to control the plurality of valve means 260 to exert a suction force in the zones Z1, Z2 upstream of the front edge f of the medium M, at least shortly before the front edge f arrives underneath the printhead 500. The air flow caused by the movement of the cardboard M may follow first a convex path caused by the movement and next a concave path caused by the suction through the holes 110 in zone Z1 between the front edge f and the area below the printhead 500.

The media transport system may further comprise a measuring device 700, such as a camera, a scanner, one or more sensors, configured for detecting a position of at least a front edge f of the medium M, wherein the control means 400b is configured to control the valve means 260 in function of the position of the front edge f detected by the measuring device 700.

In the illustrated embodiment, the carrier 100, 200 is provided with a plurality of passages 250b ending in the plurality of holes 110 in the upper surface 101. The passage 250b in zone Z1 has a wall oriented at an angle a smaller than 90 degrees with respect to the upper surface 101. For example, angles between 30 and 70 degrees may be used to create a suction flow which is not vertical with respect to the upper surface, and which follows more or less the flow lines of the air flow to be evacuated. More in particular, the inclination may be oriented in an upstream direction, i.e. in the direction of an approaching front edge f. In zone Z2, downstream of the printhead 500, the passages 250b may be inclined in the opposite direction, such that air flows underneath the printhead are limited or avoided. Indeed, by giving the passages 250b in zone Z2 an inclination in the movement direction, the suction flow is oriented away from the printhead 500. For example, the passages 250b upstream of the printhead 500 (in zone Z1) may have a mirror shape of the passages 250b downstream of the printhead 500 (in zone Z2). In other zones of the carrier 100, 200, any one of the implementations described before for the suction groups 250 may be used.

In the description provided above, it is described that the valve means 260 are controlled. However, when a plurality of suction means 300 (S1, S2) is present, as in the embodiment of FIGS. 1C and 1D, in addition or alternatively, it is also possible to control the plurality of suction means 300 using a control means 400a. It is noted that the control means 400b and 400a may be part of the same control unit or may be separate control units.

More generally, the printing apparatus may comprise a control means 400a, 400b configured for controlling the plurality of valve means 260 and/or the at least one suction means 300 in function of the distance between said valve means 260 and the one or more printheads 500 and/or in function of an operation state of the one or more printheads 500 and/or in function of a speed of the print medium M and/or in function of a position of the print medium M on the carrier and/or in function of a position of the front edge f of the print medium M, etc.

In the embodiment of FIGS. 10A and 10B, the flow control means 2000 is integrated in the media transport system. The controllers 400a, 400b may be configured to control the at least one suction arrangements 250 and/or the at least one suction means 300, such that the suction generated in an area where a medium is present is stronger than the suction generated in an area where no medium is present.

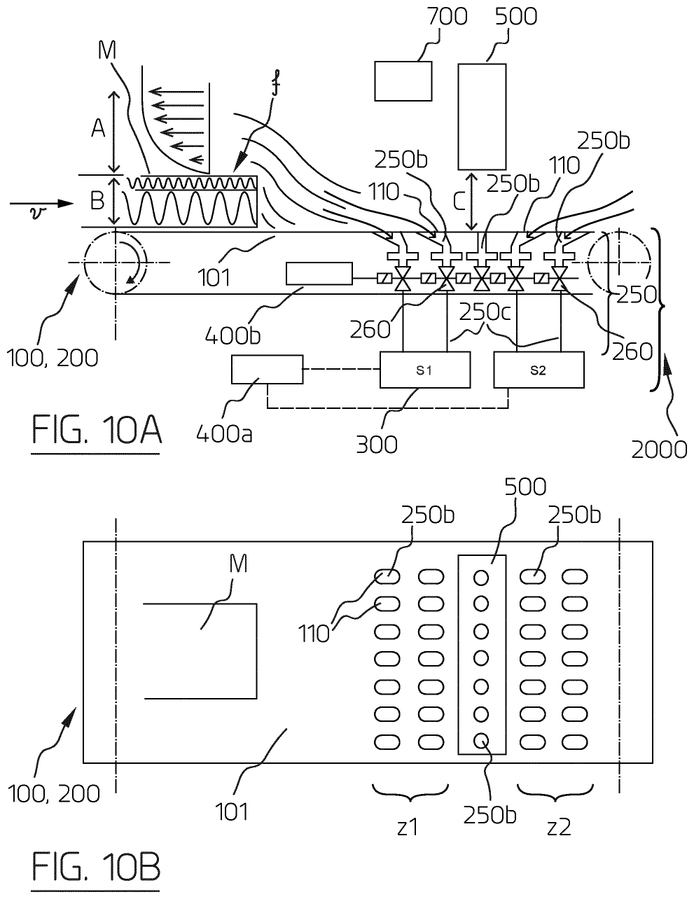

FIG. 11 illustrates another exemplary embodiment of a contact-less liquid application apparatus, and in particular a printing apparatus, for applying a liquid in a contact-less manner on a moving medium M. The liquid application apparatus comprises a liquid application means 500 configured for applying a liquid on the moving medium M, and a media transport system 1000 configured for moving the medium M in a movement direction v at a distance of the liquid application means 500. The liquid application means may be one or more print heads, e.g. one or more inkjet printheads. The liquid application apparatus further comprises a flow control means 2000 configured to evacuate at least a portion of the air displaced by the moving of the medium M, at least before the medium is in a liquid application position, but in the embodiment of FIG. 11, the flow control means 2000 may continue to operate during application of the liquid by the liquid application means 500. A liquid application position is a position in which the liquid application means 500 is applying liquid on the medium. FIG. 11 illustrates the medium M before it is in the liquid application position.

The flow control means 2000 is configured to evacuate at least a portion of the air displaced by the moving of the medium in a zone upstream of the liquid application means 500. The evacuation may take place in a zone before a front edge f of the medium M, but also above the medium M when the medium M is in a liquid application position. Although not illustrated, the skilled person understands that similar flow control means may be provided to evacuate at least a portion of the air displaced by the moving of the medium in a zone behind a trailing edge of the medium M and/or in a zone next to one or more side edges of the medium.

The flow control means 2000 may be configured to evacuate at least a portion of the air displaced by the moving of the medium M, taking into account at least one of: the moving speed v, a position of the medium M in the media transport system 1000, an operation state of the liquid application means 500. Optionally, a measuring device 700 configured for detecting a position of the front edge f and/or a peripheral edge of the medium, may be provided. The flow control means 2000 may then be configured to evacuate at least a portion of the air displaced by the moving of the medium M, taking into account the position detected by the measuring device. The control flow means 2000 may be configured to generate a suction flow shortly before the front edge f reaches an area opposite the liquid application means, and such that the suction flow is reduced when the liquid application means 500 have started applying liquid onto the medium. More in particular, the suction flow behaviour may be optimized to avoid or limit any disturbance of the application of liquid by the liquid application means 500.

To shape the air flow appropriately, the control flow means 2000 comprises at least one passage 2250b located upstream of the liquid application means 500 and having an inclination configured for guiding the suction flow away from a liquid application area A and from the path followed by the liquid leaving the liquid application means 500. The shape of an inlet 2210 of the passage 2250b may be substantially any one of the following or a combination thereof: round, rectangular, ring-shaped, oval, polygonal.

The flow control means 2000 comprises at least one suction means 2300 connected via at least one suction arrangement 2250 comprising the above described passage 2250b. Optionally a valve means (not illustrated) may be included in the suction arrangement 2250. The flow control means 2000 further comprises a controller 2400 configured for controlling the at least one suction arrangement 2250 and/or the at least one suction means 2300 such that at least a portion of the air displaced by the moving of the medium, is evacuated through the above described passage 2250b. The flow control means 2000 is configured to deflect at least a portion of the air displaced by the moving of the medium M, away from the media transport system 1000, towards a zone upstream of the liquid application means 500. The flow control means 2000 may be at least partially integrated in the liquid application means 500.

In the embodiment of FIG. 11, a liquid is applied in a contact-less manner on the moving medium M by: transporting the medium M in a movement direction with a movement speed v; evacuating at least a portion of the air displaced by the transporting of the medium M, at least before the medium M is in a liquid application position; and applying liquid on said medium M in a contact-less manner, when the medium M has reached the liquid application position and whilst the medium is moving at the movement speed v. The transporting may be done on a carrier with a support surface, for example a carrier as described in the previous embodiments, but this may also be a different carrier. Optionally the evacuation described in FIGS. 10A and 10B may be combined with the evacuation described in FIG. 11.

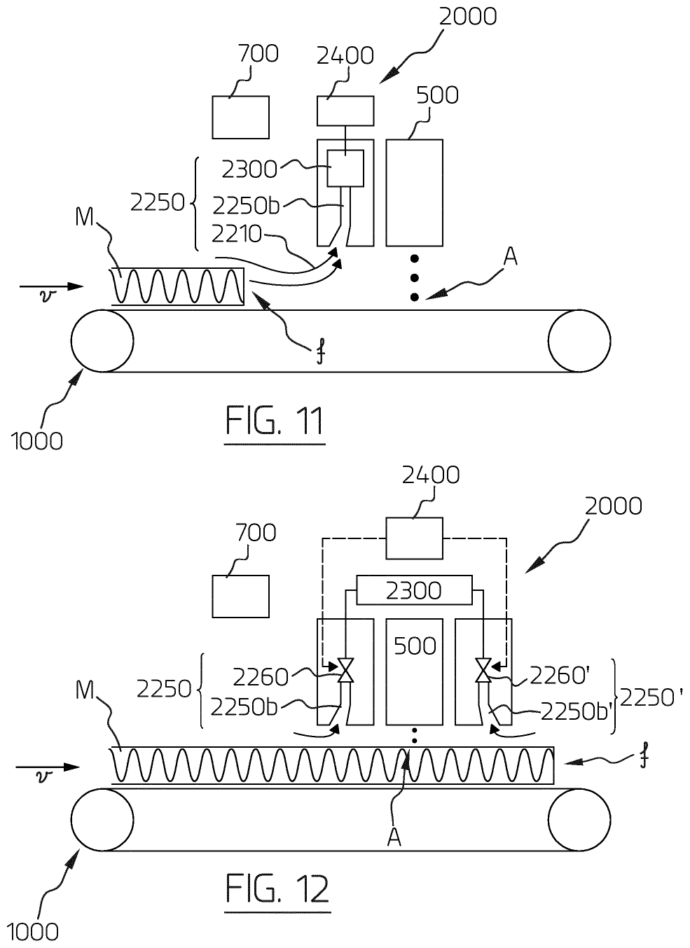

The embodiment of FIG. 12 is similar to the embodiment of FIG. 11, with this difference that the flow control means 2000 comprises a first suction arrangement 2250 upstream of the liquid application means 500, and a second suction arrangement 2250′ downstream of the liquid application means 500. Further, the suction arrangements 2250, 2250′ each comprise a valve means 2260, 2260′ controlled by a controller 2400, and there is provided a common suction means 2300 for the suction arrangements 2250, 2250′.

To shape the air flow appropriately, the first suction arrangement 2250 comprises at least one passage 2250b located upstream of the liquid application means 500 and having an inclination configured for guiding the suction flow away from a liquid application area A and from the path followed by the liquid leaving the liquid application means 500. Similarly, the second suction arrangement 2250′ comprises at least one passage 2250b′ located upstream of the liquid application means 500 and having an inclination configured for guiding the suction flow away from a liquid application area A and from the path followed by the liquid leaving the liquid application means 500. The shape of an inlets 2210, 2210′ of the passages 2250b, 2250b′ may be substantially any one of the following or a combination thereof: round, rectangular, ring-shaped, oval, polygonal. More in particular, the passages 2250b, 2250b′ may be shaped in a similar manner as the passage 250b described above in connection with FIGS. 10A and 10B but mirrored around a horizontal plane.

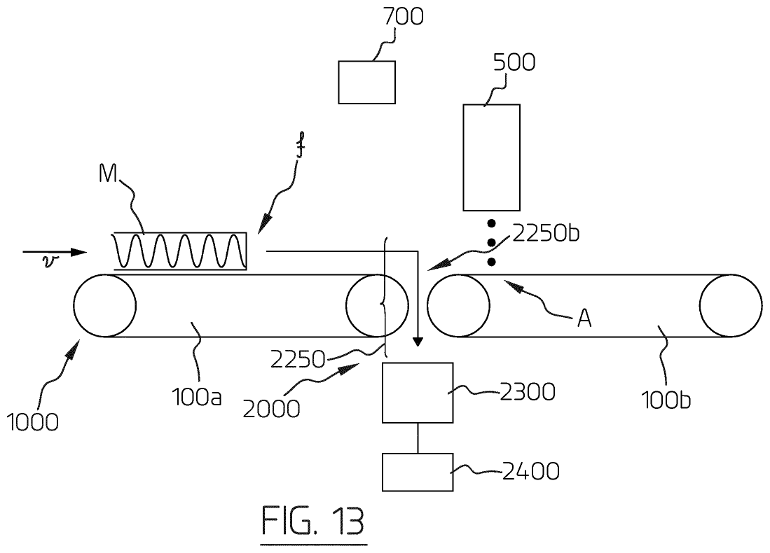

FIG. 13 illustrates yet another exemplary embodiment of a liquid application means for which similar components have been indicated with the same reference numerals. In this embodiment, the flow control means 2000 comprises at least one suction means 2300 connected via at least one suction arrangement 2250 comprising a passage 2250b through the media transport system 1000 at a location upstream of a liquid application area A. To that end, as illustrated, the media transport system 100 may comprises two carriers 100a, 100b, e.g. two belts, placed at a small distance of each other. Optionally a valve means (not illustrated) may be included in the suction arrangement 2250. The flow control means 2000 further comprises a controller 2400 configured for controlling the at least one suction arrangement 2250 and/or the at least one suction means 2300 such that at least a portion of the air displaced by the moving of the medium, is evacuated through the above described passage 2250b. The flow control means 2000 is configured to deflect at least a portion of the air displaced by the moving of the medium M, through the media transport system 1000.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination, and any advantageous combinations of such claims are herewith disclosed. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A contact-less liquid application apparatus for applying a liquid in a contact-less manner on a moving medium, said liquid application apparatus comprising:
a liquid application means configured for applying a liquid on a moving medium;
a media transport system configured for moving the medium in a movement direction at a distance of the liquid application means; and
a flow control means configured to evacuate at least a portion of the air displaced by the moving of the medium, at least before the medium is in a liquid application position, said liquid application position being a position in which the liquid application means is applying liquid on the medium.

2. The liquid application apparatus of claim 1, wherein the flow control means is configured to evacuate at least a portion of the air displaced by the moving of the medium in a zone upstream of the liquid application means and/or between the liquid application means and the media transport system.

3. The liquid application apparatus of claim 1, wherein the flow control means is configured to evacuate at least a portion of the air displaced by the moving of the medium in a zone before a front edge of the medium.

4. The liquid application apparatus of claim 1, wherein the flow control means is configured to evacuate at least a portion of the air displaced by the moving of the medium in a zone behind a trailing edge of the medium and/or in a zone next to one or more side edges of the medium and/or in a zone adjacent the medium.

5. The liquid application apparatus of claim 1, wherein the flow control means is configured to evacuate at least a portion of the air displaced by the moving of the medium, based on at least one of: the moving speed (v), a position of the medium (M) on the media transport system, and an operation state of the liquid application means.

6. The liquid application apparatus of claim 1, further comprising a measuring device configured for detecting a position of a front edge and/or a peripheral edge of the medium, wherein the flow control means is configured to evacuate at least a portion of the air displaced by the moving of the medium, based on the position detected by the measuring device.

7. The liquid application apparatus of claim 1, wherein the control flow means is configured to generate a suction flow shortly before the front edge reaches an area opposite the liquid application means, and such that the suction flow is reduced or stopped when the liquid application means have started applying liquid onto the medium.

8. The liquid application apparatus of claim 1, wherein the control flow means comprises at least one passage comprising:
a passage located upstream of the liquid application means and having an inclination configured for guiding the suction flow away from a liquid application area; and/or
a passage downstream of the liquid application means and having an inclination configured for guiding the suction flow away from a liquid application area.

9. The liquid application apparatus of claim 1, wherein the liquid application means comprises one or more printheads.

10. The liquid application apparatus of claim 1, wherein the flow control means comprises at least one suction means connected via at least one suction arrangement; and a controller configured for controlling the at least one suction arrangement and/or the at least one suction means such that at least a portion of the air displaced by the moving of the medium, is evacuated through the at least one hole.

11. The liquid application apparatus of claim 10, wherein the at least one suction arrangement comprises at least one valve means configured to regulate a suction flow in the at least one suction arrangement.

12. The liquid application apparatus of claim 11, wherein the media transport system comprises:
a carrier having a support surface with at least one hole, said carrier being configured for supporting the medium on the support surface thereof; and
a drive means configured for moving at least a portion of the carrier with the medium or for moving the medium relative to the carrier, in the movement direction with a moving speed;
wherein the flow control means is integrated in the media transport system and the at least one suction means is connected via at least one suction arrangement to the at least one hole.

13. The liquid application apparatus of claim 12, wherein the controller is configured to control the at least one suction arrangements and/or the at least one suction means, such that the suction generated in an area where a medium is present is stronger than the suction generated in an area where no medium is present.

14. The liquid application apparatus of claim 12, wherein the carrier is provided with at least one passage ending in the at least one hole in the support surface, wherein the at least one passage comprises one or more of:
a passage located upstream of the liquid application means and having an inclination configured for guiding the suction flow along the support surface of the carrier away from a liquid application area;
a passage downstream of the liquid application means and having an inclination configured for guiding the suction flow along the support surface of the carrier away from a liquid application area; and
a passage opposite the liquid application means.

15. The liquid application apparatus of claim 12, wherein the drive means is configured for moving at least the support surface of the carrier with the medium; wherein the carrier comprises a movable plate or belt with the at least one hole and a static support structure, and the drive means is configured to move the plate or belt; and wherein the at least one suction arrangement extends in the static support structure.

16-17. (canceled)

18. The liquid application apparatus of claim 12, wherein the drive means is configured for moving the medium relative to the carrier, and the carrier is static.

19. The liquid application apparatus of claim 12, wherein the at least one hole comprises more than 100 holes, wherein the distance between adjacent holes is between 1 mm and 400 mm.

20. The liquid application apparatus of claim 12, wherein the controller is configured to control the at least one suction arrangement and/or the at least one suction means to exert a suction force through the at least one hole between a front edge of the medium and an area opposite the liquid application means and/or in the area opposite the liquid application means, at least before the front edge reaches said area.

21. The liquid application apparatus of claim 1, wherein the flow control means is configured to deflect at least a portion of the air displaced by the moving of the medium, away from the media transport system, towards a zone upstream and/or downstream of the liquid application means; and wherein the flow control means is at least partially integrated in the liquid application means.

22. (canceled)

23. A liquid application method for applying a liquid in a contact-less manner on a moving medium, said method comprising the steps of:
transporting a medium in a movement direction with a movement speed;
evacuating at least a portion of the air displaced by the transporting of the medium, at least before the medium is in a liquid application position; and
applying liquid on said medium in a contact-less manner when the medium has reached the liquid application position and while the medium is moving at the movement speed.

24-31. (canceled)
